(19) United States
(12) Patent Application Publication
(10) Pub. No.: US 2007/0050751 A1
(43) Pub. Date: Mar. 1, 2007

(54) Automatic interoperation with legacy POS service and control objects

(75) Inventors: Harlan Husmann, Woodinville, WA (US); Craig A. Jensen, Sammamish, WA (US); Janine A. Harrison, Redmond, WA (US); Sergey I. Bykov, Redmond, WA (US); Timothy E. Belvin, Auburn, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/217,633

(22) Filed: Aug. 31, 2005

(51) Int. Cl. G06F 9/44

(52) U.S. Cl. 717/105

(57) ABSTRACT

Automatic interoperation functionality for legacy POS service and control objects is provided. In response to a request for creating an instance for a control object that implements an interface for the POS device, a legacy interoperability subsystem determines a unique identifier associated with the control object. The legacy interoperability subsystem dynamically generates an in-memory proxy class, based on the unique identifier. Thereby, the legacy subsystem enables the POS service application and the POS device to communicate with each other without having to instantiate one or more proxy classes for each instance of the legacy control object.

### BACKGROUND

Retail devices generally refer to computing devices that are used in retail sales and inventory operations. The wide variety of retail devices ranges from cash drawers, barcode scanners, receipt printers, etc. To establish uniformity and coherence in communications between different retail devices, a number of standards have been developed. OLE for Point of Sale/Service (OPOS), JavaPOS, and the relatively recent UnifiedPOS (UPOS) specifications are examples of such standardization attempts.

Point of Sale/Service (POS) devices may be controlled by individual controllers, remote servers, and other computing devices. Communication with POS devices involves setting of operational parameters, receiving collected information, statistics information, load distribution, and the like.

### SUMMARY

In response to a request for creating an instance for a control object that implements an interface for a POS device, an identifier associated with the control object is determined. An in-memory proxy class is then generated dynamically based on the identifier.

According to some aspects, a legacy interoperability subsystem may generate the in-memory proxy class based on a legacy proxy class associated with the control object. Communication between the POS service application and a legacy POS device is enabled by the in-memory legacy proxy class providing calls from the POS device to one or more event handlers of the legacy proxy class and the legacy proxy class translating and providing the calls to the POS application. By generating the in-memory proxy class, instantiating one or more proxy classes for each instance of the legacy control object is avoided.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device that may be used according to an example embodiment;

FIG. 2 illustrates an example system of POS devices managed by a POS server over a network, where one example embodiment may be implemented;

FIG. 3 illustrates a general system diagram of a POS retail system;

FIG. 4 illustrates a high-level architecture diagram for POS system;

FIG. 5 illustrates interaction between the POS system and the POS for .NET;

FIG. 6 illustrates an example architecture for integrating legacy devices with the POS retail system according to one embodiment;

FIG. 7 shows example helper classes and Service Object (SO) repositories within the .NET framework (in WIN32 platform); and

FIG. 8 is a logic flow diagram illustrating a process for automatic interoperation of legacy POS service and control objects.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Throughout the specification, the following terms are defined as follows, unless the context clearly dictates otherwise. The term “OPOS” refers to OLE for Point of Sale or Service. The term “UPOS” refers to the Unified Specification for Point of Sale or Service. The term “COM” refers to Component Object Model. The term “POS Class Peripheral” or “OPOS device” refers to the collection of devices that fall into one of 24 different device classes as defined in the UPOS V1.8 specification. The term “device class” is a category of POS devices that share a consistent set of properties, methods, and events. Examples are Cash Drawers and POS Printers. Some devices support more than one device class. For example, some POS Printers include a Cash Drawer. The term “control object (CO)” refers to an object that exposes the set of properties, methods, and events to an application for a specific device class. The term “service object (SO)” refers to an object that implements the UPOS prescribed functionality for a specific device. An SO can be implemented in any programming language. The term “unsupported device” or “non-supported device” refers to any device that is not, by default, supported by UPOS.

Interoperation between .NET applications and legacy POS devices may be accomplished, among other aspects, by enabling integration with events. For integration of events, a dynamic in-memory class derived from a respective legacy proxy class is generated dynamically instead of instantiating a legacy proxy class for every instance of legacy control object. The dynamic in-memory class then implements the event sink interface of the CO, which is to be wrapped by the legacy proxy class. The generated class simply relays calls to event handlers through the legacy proxy class, which translates and conveys them to application.

Illustrative Operating Environment

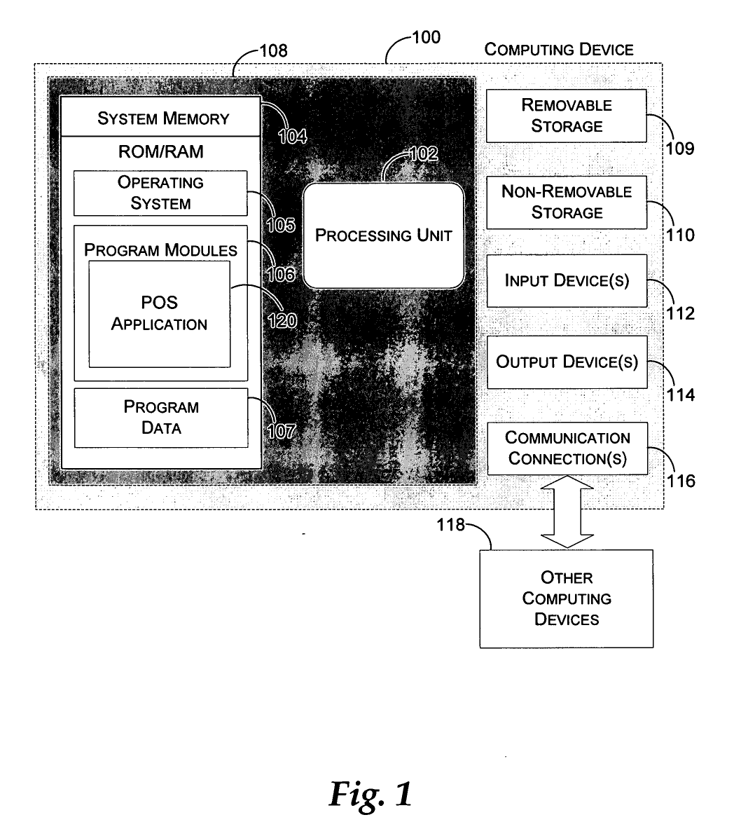

Referring to FIG. 1, an exemplary system for implementing the invention includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105, one or more program modules 106, and may include program data 107. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

In one embodiment, program modules 106 further include POS application 120, which is arranged to communicate with legacy and non-legacy POS devices, manage operation of such devices, receive data from the POS devices, and the like. POS application 120 may interact with other computing devices through communication connection(s) 116.

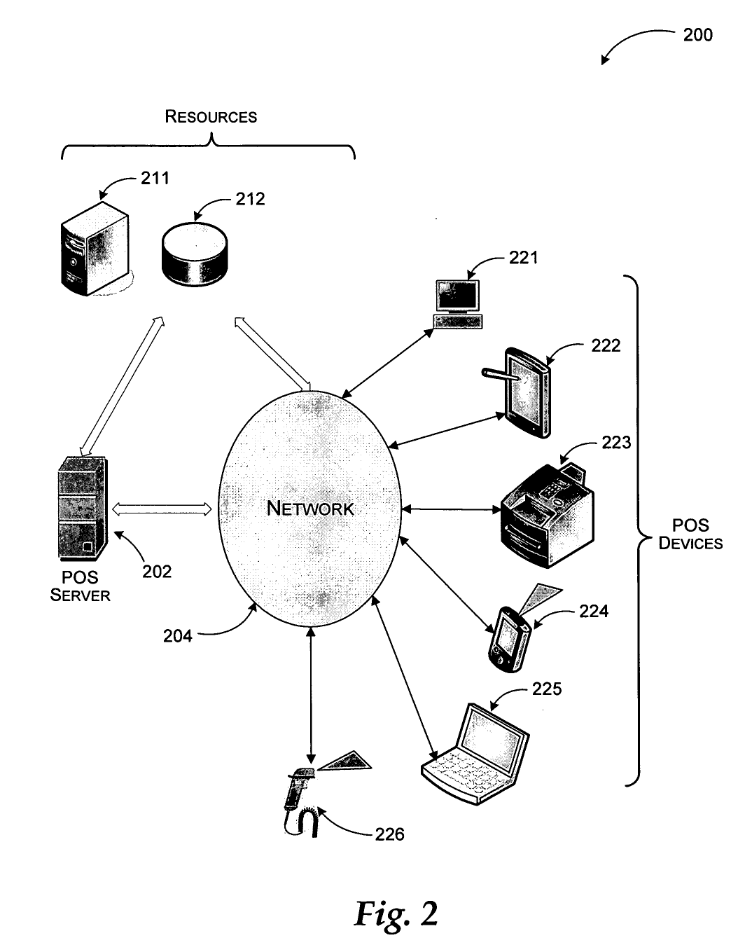

FIG. 2 illustrates example system 200 of POS devices managed by a POS server over a network, where one example embodiment of automatic interoperation of legacy POS service and control objects may be implemented.

System 200 may comprise any topology of servers, clients, Internet service providers, and communication media. Also, system 200 may have a static or dynamic topology.

System 200 includes at least one POS server 202, which provides services to other nodes of network 204 that may include client devices 221-226 directly connected to network 204 such as terminal 221, PDA 222, cash register 223, handheld terminal with scanner 224, laptop computer 225, and handheld scanner 226. In one embodiment, nodes of network 204 may further include other devices (not shown), which are connected to network 204 through a subnet managed by another POS server (not shown). Services provided by POS server 202 may include an application that manages POS devices 221-226, receives data from the POS devices, processes and shares the data with other resources, and the like.

In one embodiment, the POS devices may include a bump bar; a cash changer; a cash drawer; a credit authorization terminal; a coin dispenser; a fiscal printer; a hard total; a keylock; a bar code scanner; a tone indicator; a motion detector; a line display; a magnetic ink character recognition reader; a magnetic stripe reader; a PIN pad; a point card; a POS keyboard; a POS printer; a remote order display; a scale; a signature capture; and a check image scanner.

Resources may include applications on other servers (or clients) such as server 211, database 212, and other applications on computing devices (not shown), where information is transferred to a recipient. Network 204 may be a secure network such an enterprise network, or an unsecure network such as a wireless open network.

Network 204 provides communication between the nodes described above. By way of example, and not limitation, network 204 may include wired media such as a wired network or direct-wired connection, and wireless media such as acoustic, RF, infrared and other wireless media.

In one example embodiment of the present invention, a POS application on POS server 202 may receive inventory data from handheld scanner 226 and similar devices, and update inventory information in database 212. The POS application may be a .NET application, while some of the POS devices it manages are COM-architecture based devices.

One category of devices that use both COM and .NET technologies is POS devices that are commonly used by retail businesses. Widely implemented OPOS standard employs COM technology for communication between applications and POS devices. OPOS standard may be viewed as a specific case of the more general UPOS standard, which defines an architecture where the interface to a POS device consists of two software modules: a Control Object (CO) which acts as a device-independent interface between the application and the device, and a Service Object (SO) which acts as a device-dependent interface between the corresponding CO and the device itself.

Under the umbrella UPOS standard, other specifications such as Java-POS are also developed. Implementing different architectures presents the issue of interoperation between new applications and legacy devices. For example, in the retail industry, the OPOS implementation is by far more common. Thus, a majority of manufacturers of POS devices have built OPOS (i.e., COM) CO's and SO's for their devices. For anyone creating a new implementation of UPOS (e.g. a .NET implementation) being able to interoperate with legacy OPOS devices (and their CO's and SO's) is important.

While the COM and .NET technologies are compatible, there are points of incompatibility that may result in degraded operation of legacy devices or even no communication between the application and the legacy POS device. COM interoperation provides a solution for properties, methods and events. However, it requires a COM type library, which defines interface IDs (guids). OPOS does not include a single standard type library for COs. As a result, there exist multiple implementations of COs based on incompatible type libraries. That incompatibility of the type libraries makes it difficult to interoperate with COM events.

Embodiments described herein address compatibility issues between legacy COM POS devices and .NET applications and enable COM events from incompatible type libraries at runtime. The scope of the present disclosure is not limited to supporting retail POS devices. Any device that is not included within the operating system's list of supported POS devices may be supported.

Illustrative Embodiments For Automatic Interoperation of Legacy POS Service and Control Objects

Embodiments are related to automatic interoperation of legacy COM POS service and control objects.

The Microsoft POS for .NET library supports both new generation .NET-based service objects and legacy COM-based service objects. Both types of SO's are exposed to POS applications via the same interface such that the difference is transparent to the applications.

In order to expose the interface of a legacy SO, the library wraps legacy COM-based CO/SO pair with a managed proxy class. The proxy instantiates the SO's control object via .NET Reflection and relays application calls between the application and CO. The proxy communicates to the interface of the CO, which in turns communicates with the interface of the SO.

To integrate a legacy OPOS COM SO-CO pair successfully, the library gets and/or sets properties of the CO, invokes its methods, and receives its events. Moreover, early bindings are not helpful because the architecture supports any CO and not just specific ones. Therefore, the library leverages .NET reflection as a late binding mechanism. Reflection works well for properties and methods, but does not provide for interoperation with POS.NET COs in COM events.

The POS for .NET defines base classes for legacy proxies: one per supported device type (e.g. LegacyScanner). These classes derive from the non-legacy (i.e. native .NET) interface classes. For example, LegacyScanner derives from Scanner.

Legacy proxy classes use LegacyProxy—a helper class, which implements common properties and methods. Legacy proxies communicate to CO's via the standard .NET-COM interoperability layer that performs actions associated with communication infrastructure and uses IDispatch for actual communication. Because IDispatch invokes properties and methods by names, proxy classes can access the properties and methods as long as the underlying CO implements them. Accordingly, a library of the type of the CO is not needed.

Events coming from legacy CO's are transferred to the application by means of UCOMIConnectionPointContainer and UCOMIConnectionPoint interfaces from System.Runtime.InteropServices namespace. Event handlers can be set by UCOMIConnectionPoint only if the event receiver class (legacy proxy) implements the specific event sink interface of the legacy control. Although OPOS defines just five standard events, event sink interfaces are different for different control objects. Specific interface IDs (guids) are not defined by the OPOS standard. As a result, scanner COs from two manufacturers may have different guids for the same interface defined by OPOS.

According to one embodiment, a dynamic in-memory class derived from a respective legacy proxy class is generated dynamically instead of instantiating a legacy proxy classes for every instance of legacy control object. The dynamic in-memory class implements the event sink interface of the CO, which is to be wrapped by the legacy proxy class. The guid of the interface is retrieved from the event connection point of the legacy CO instance (via UCOMIConnectionPoint). The generated class simply relays calls to event handlers through the legacy proxy class, which translates and conveys them to application.

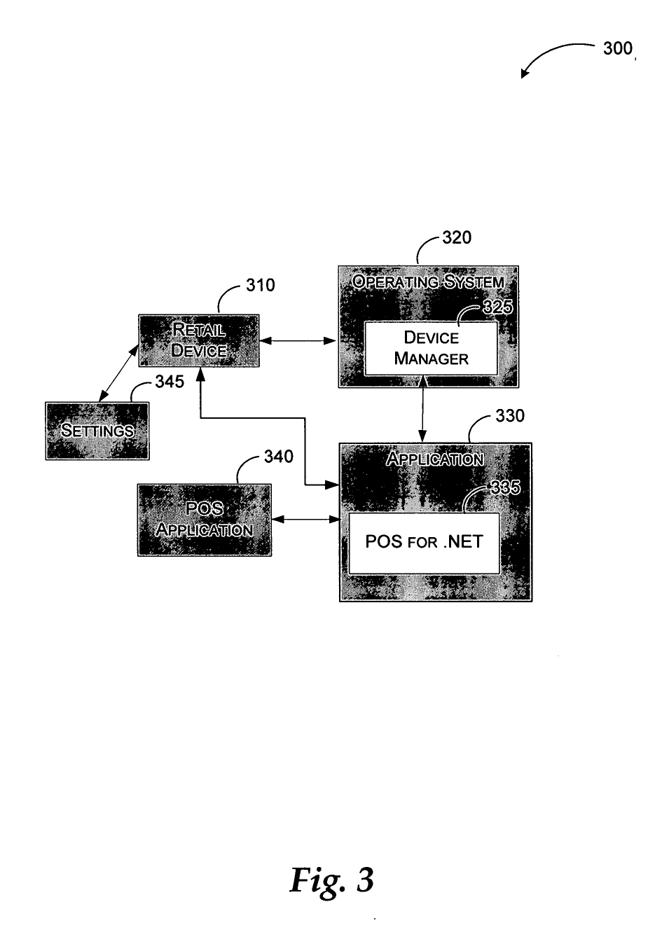

FIG. 3 illustrates a general system diagram of POS retail system 300, in accordance with aspects of the present disclosure. Automated legacy device interoperation for the retail devices simplifies the task of installing, operating, and maintaining of the POS devices.

In one embodiment, device manager 325, application 330, which includes POS for .NET 335, and POS application 340 may interact to manage retail device 310.

POS for .NET 335 is directed at providing applications with properties, methods, and events associated with supported devices. According to one embodiment, POS for .NET 335 exposes UPOS properties, methods and events as managed code for each of the supported device classes through a .NET class library.

POS for .NET 335 defines base classes for legacy proxies: one per supported device type. These classes may derive from the non-legacy interface classes. Events coming from legacy CO's are transferred to POS application 340. According to one embodiment, a dynamic in-memory class derived from a respective legacy proxy class is generated dynamically instead of instantiating a legacy proxy classes for every instance of legacy control object. The dynamic in-memory class implements the event sink interface of the CO, which is to be wrapped by the legacy proxy class. The guid of the interface is retrieved from the event connection point of the legacy CO instance. The generated class then transfers calls to event handlers through the legacy proxy class, which translates and conveys them to application.

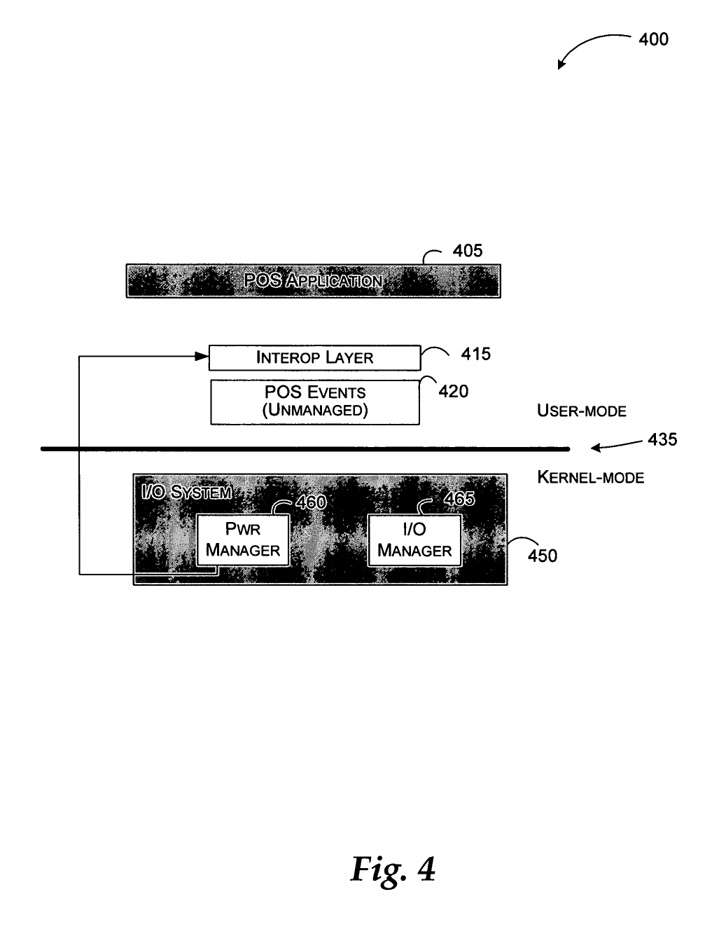

FIG. 4 illustrates a high-level architecture diagram for POS system 400. As illustrated, the architecture diagram includes functionality provided by the operating system in kernel-mode (below line 435) and functionality provided in user-mode (above line 435).

I/O system 450 operates at the kernel mode of an operating system and provides I/O management (465) and power management (460). I/O manager 465 provides standard I/O management. Power manager 460 sends power events that are not managed by the operating system.

Interoperability layer 415 is used to enable legacy COM based retail devices to be able to be used by applications targeting the POS for .NET. In other words, interoperability layer 415 is directed at providing POS application 405 a unified way of accessing both PnP devices and legacy devices using the same methods. Legacy OPOS devices generally store information about themselves, identify the communication path, and to persist configuration data. For example, a system registry may be used to store this information. Typically, each device manufacturer would provide a custom application to manage the configuration of the device.

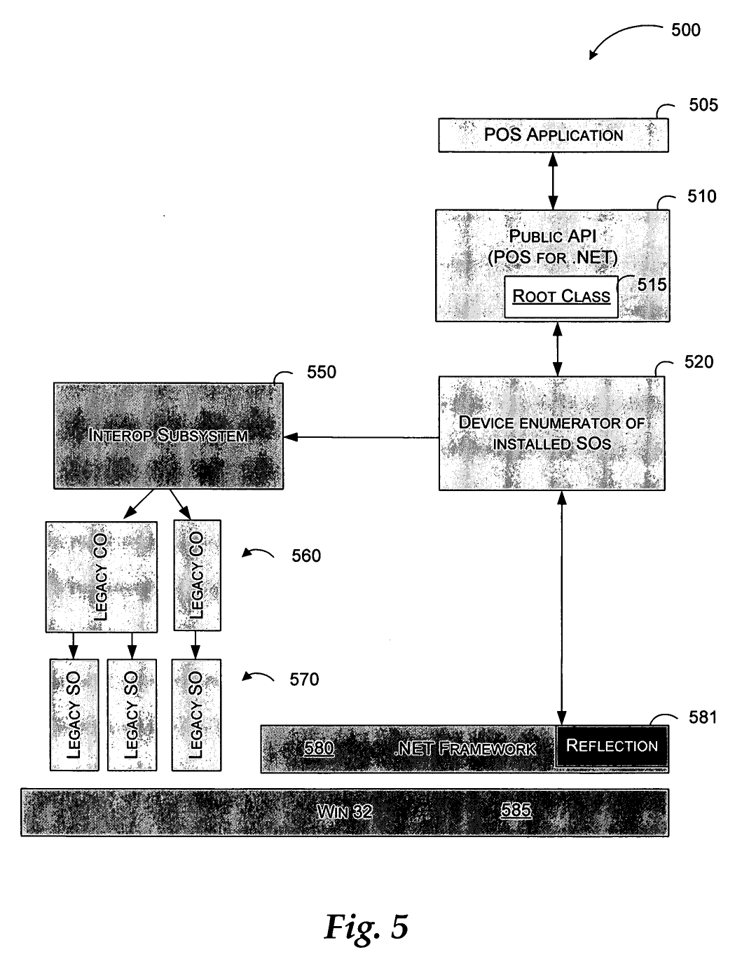

FIG. 5 includes system 500 illustrating interaction between the POS system and the POS for .NET. As illustrated, system 500 includes POS application 505, public API (POS for .NET) 510, device enumerator 520, reflection 581, legacy interop subsystem 550, legacy CO's 560, legacy SO's 570, and a .NET framework and Win 32 level (580 and 585). Reflection mechanism is a feature of .NET framework 580.

POS for .NET 510 wraps COM-based SOs with a managed proxy class. The proxy instantiates SO's control object via reflection 581 and relays application calls to it. The proxy does not directly talk to the actual SO (570). Instead it communicates with its CO (560).

The LegacyProxy class is a universal base class for legacy proxies. The LegacyProxy class implements interfaces for the 24 currently supported OPOS devices classes (ICashDrawer, IMSR, IPOSPrinter, etc.) so that instances of it can be cast to any one of the interfaces. Essentially, LegacyProxy is a superset of OPOS controls. LegacyProxy talks to a CO via standard .NET-COM interoperability layer that takes care of plumbing and uses IDispatch for actual communication. Since IDispatch invokes properties and methods by names, the LegacyProxy class is able to expose the properties and methods as long as the underlying CO implements them.

The POS for .NET (510) may consist of three core assemblies: a class that defines interfaces, enums, and constants and that is referenced by both SOs and applications; a second class that contains PosExplorer class which lets applications (ISV) enumerate and instantiate service objects for installed POS devices; and a third base class for a service object. Writers of service objects (IHV) may be encouraged to derive from it and leverage its default implementation of basic SO functionality like event queue, global claim, etc.

Several interfaces are defined for the purpose of creating managed Service Objects. These interfaces encapsulate the POS 1.8 specification and are divided into two categories: (1) device class independent interfaces that model common POS functionality; and (2) device dependent interfaces that model functionality specific to a given class of devices.

Publicly exposed POS interfaces (common and device dependent ones) may be defined in a separate class. These interfaces are implemented by .NET service objects. Applications cast SO instances received from the POS for .NET to these interfaces to access specific functionality of particular device classes. Base control interfaces are defined in an interface namespace and have the following hierarchy. PosDevice is a base interface for .NET service objects. SOs implement it directly or indirectly. The library uses pointers to this interface for SOs and applications cast it to more specific device dependent interfaces like Msr, PosPrinter, etc

Device dependent interfaces for standard OPOS device classes are defined in a specific interface namespace. They derive from PosDevice and extend it with functionality specific for particular device classes. IHV's derive from these interfaces when implementing their SO's. Exemplary interfaces are as follows: CashDrawer for cash drawer; Msr for magnetic stripe reader; PosPrinter for receipt printer; and the like.

The interfaces have PosDevice as their parent/grandparent, so any SO can be cast to PosDevice interface. The library classes operate with PosDevice interfaces and applications cast instances of SOs to the device specific interfaces. That allows introducing new device classes without changing the library. As long as the new device class interface is derived from PosDevice, the library will be able to handle SO instances for the new device class.

To integrate a legacy OPOS COM SO-CO pair successfully, the library gets and/or sets properties of the CO, invokes its methods, and receives its events. Moreover, early bindings are not useful because the architecture supports any CO and not just specific ones. Therefore, the library leverages .NET reflection 581 as a late binding mechanism. Reflection 581 works well for properties and methods, but does not provide for interoperation with POS.NET COs in COM events.

POS for .NET 510 communicates with POS application 505 and exposes an enumerator of available POS devices grouped by UPOS device class. The library serves as a factory for instantiating instances of service objects. It decouples writers of POS applications from implementation of specific service objects and is a single entry point for applications for interacting with POS devices.

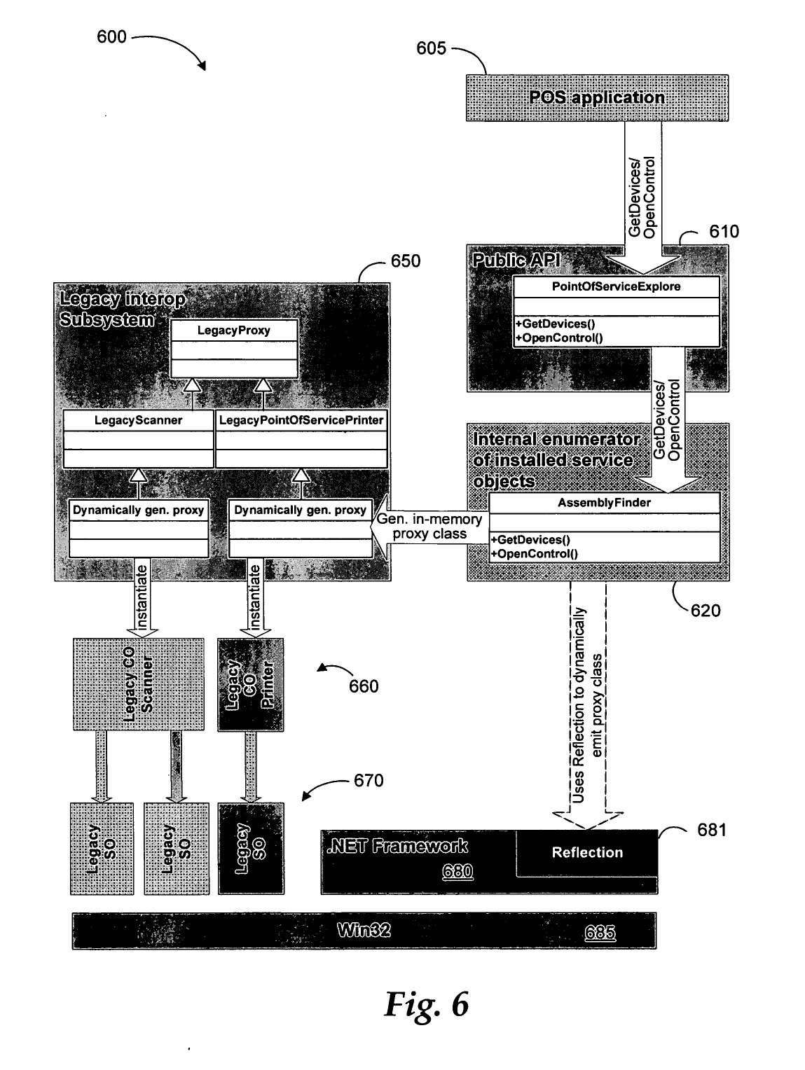

FIG. 6 includes system 600 illustrating an example architecture for integrating legacy devices with the POS retail system according to one embodiment. Components of system 600 that are similarly numbered as components of system 500 of FIG. 5 are arranged to operate in a likewise manner except where stated otherwise.

In example system 600, POS application 605 begins the process by calling PosExplorer. CreateInstance for a legacy OPOS control. In response to the CreateInstance call, Public API (POS for .NET) 610 relays the CreateInstance call to AssemblyFinder class in internal enumerator of installed SOs 620.

AssemblyFinder. CreateInstance understands that the request is for a legacy control and calls AssemblyFinder. GenerateLegacyProxy. In one embodiment, reflection 681 within .NET framework 680 may be used to dynamically emit proxy class. Upon getting the guid of the event sink interface, AssemblyFinder. GenerateLegacyProxy calls AssemblyFinder.EmitProxy to generate an in-memory proxy class that implements an interface with the event sink guid.

In the example system, legacy interoperability subsystem 650 dynamically generates the in-memory proxy class for an example legacy scanner and a legacy POS printer. For each legacy POS device, there are COs 660 that provide interface to the SOs (670) of respective POS devices. Once the in-memory proxy class is generated, it exchanges calls with event handlers through the legacy proxy class, which in turn translates and relays the calls to POS application 605.

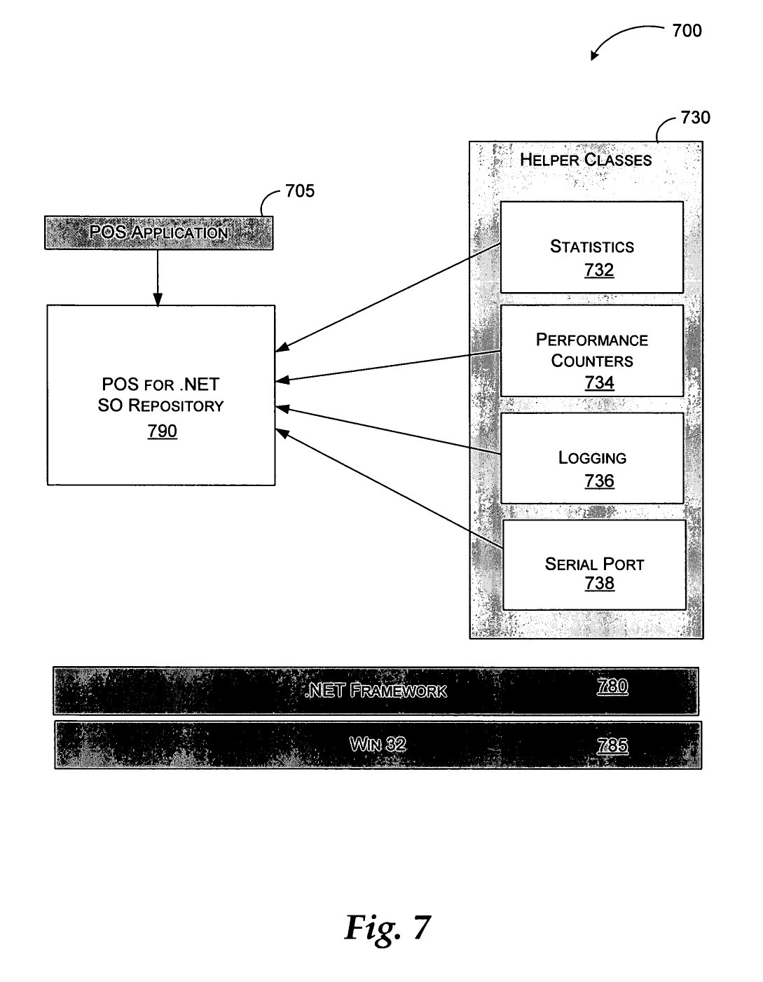

FIG. 7 shows example helper classes and SO repositories within .NET framework 780 (in WIN32 platform 785). POS application 705 talks to SO's in POS for .NET SO repository 790.

Hardware vendors typically implement a device dependent SO that implements an interface as described in the POS specification and talks directly with their hardware. The POS for .NET library includes several technologies that ease the burden to produce high quality implementations of SO's, including: support for writing Service Objects in managed code; a generic implementation of the POS features common to most service objects. This includes infrastructure for device claiming/enabling, eventing, queuing of messages, statistics, etc. IHV's can leverage this object to relieve much of the burden of implementing the POS specific aspects of SO's allowing them to concentrate on the device specific details; and a set of helper classes 730 for performance counters 734, device statistics 732, logging 736, serial port 738, etc.

According to one embodiment, service objects are written as .NET assemblies. These assemblies derive from the PosDevice interface class or one of the device-specific interfaces defined which derive from PosDevice. These assemblies include assembly-level and class-level attributes that describe the device class(es), POS versions and the hardware Id(s) of the supported devices. The POS for .NET library uses these attributes to determine which of the device classes the SO implements and what hardware it controls. By using assembly attributes, installation of SOs is significantly easier because the assembly is to be copied simply into a directory where the POS for .NET can find it.

POS for .NET SO repository 795 provides a set of base classes for SO writers. The typical scenario would be for IHV's to derive from one of the base classes or one of the device specific interfaces classes. By doing this IHV's can rely on the SO base class to handle many of the POS specific details and can concentrate their efforts on the device specific aspects of the SO.

The base class contains a default implementation for the methods and properties on the PosCommon interface. This includes a mechanism for event queuing and delivery, device state management (claiming, enabling, etc.) and state reporting. Since this is an abstract class it is directly instantiated and is intended for IHV's to derive their SO's from. Methods and properties are marked as virtual so IHV's can use the default implementations and override any methods that they see fit.

Global settings may be held in an XML configuration file. Per-SO settings are in separate XML files put to a predefined folder. The library reads both the main configuration file and configuration files from the folder when enumerating installed service objects.

IHVs have inf files for their devices that both install their drivers and copy SO assemblies and optional XML configuration files to the respective folders. ISVs and administrators are able to customize the settings by editing XML configuration files.

The POS for .NET simplifies writing .NET-based service objects by providing base classes with default implementation of common functionality. IHVs are encouraged to derive from the base classes, override provided implementation where necessary, and add device specific features. New .NET service objects are .NET classes that implement device class interfaces defined by the library.

The POS for .NET provides a generic service object class, which may be used as a base class for their service objects. The class implements as much device independent functionality as possible to simplify writing of SOs.

The POS for .NET provides a set of helper classes for functions that are likely to be desired by more than one vendor. This is directed at simplifying writing a .NET SO.

According to one embodiment, the library supports drag-n-drop style installation of .NET service objects. SO assemblies contain enough metadata information so that the POS for .NET could use it without additional configuration. An additional XML configuration file may be defined to extend the assembly metadata.

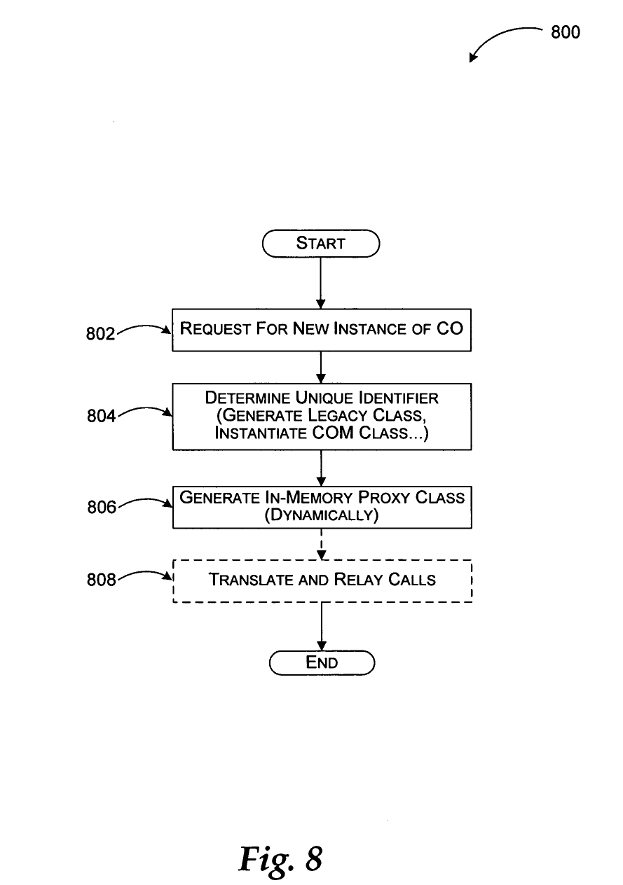

FIG. 8 is a logic flow diagram illustrating process 800 for automatic interoperation of legacy POS service and control objects. Process 800 may be performed in a POS server such as POS server 202 of FIG. 2.

As described previously, a dynamic in-memory class derived from a respective legacy proxy class may be generated dynamically instead of having legacy interoperation classes for every implementation of OPOS CO. The dynamic in-memory class implements the event sink interface of the CO, which is to be wrapped by the legacy proxy class. The guid of the interface is retrieved from the event connection point of the legacy CO instance. The generated class simply relays calls to event handlers through the legacy proxy class, which translates and conveys them to application.

The sequence of actions in an example implementation may be summarized as follows:
1. Application calls PosExplorer. CreateInstance for a legacy OPOS control.
2. CreateInstance calls GenerateLegacyProxy.
3. GenerateLegacyProxy instantiates the COM class and then uses UCOMIConnectionPointContainer and UCOMIConnectionPoint to get the guid of the connection point (event sink) interface.
4. GenerateLegacyProxy calls EmitProxy to generate an in-memory proxy class that implements an interface with the event sink guid.
5. Application opens the proxy by calling Open on it.
6. Inside the Open method, among other things, legacy proxy class (parent class of the generated proxy) calls UCOMIConnectionPoint.Advise to set the instance as event handler.

Process 800, which describes general actions for automated interoperation, begins at block 802, where POS for .NET receives a request from a POS application for creating an instance of a SO for particular physical POS device. Processing advances from block 802 to block 804.

At block 804, the POS for .NET determines a unique identifier associated with the control object. Determining the unique identifier may further involve generating a legacy proxy class that instantiates the COM class for the CO of the new POS device and getting the guid of the event sink interface. The event sink interface of the CO is to be wrapped by the legacy proxy class. The guid of the interface is retrieved from the event connection point of the legacy CO instance. Processing proceeds from block 804 to block 806.

At block 806, an in-memory proxy class is generated dynamically based on the unique identifier. The generated in-memory proxy class is arranged to simply relay calls to event handlers through the legacy proxy class. Processing then moves to optional block 808.

At optional block 808, the legacy proxy class translates and conveys the calls to the POS application enabling the POS application to communicate with the POS device seamlessly. Processing moves to a calling process from block 808 for further actions.

The blocks included in process 800 are for illustration purposes. Automatic interoperation of legacy POS service and control objects may be implemented by a similar process with fewer or additional steps including using reflection partially.

The above specification, examples and data provide a complete description of the manufacture and use of the composition of the invention. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and many embodiments of the invention can be made without departing from the spirit and scope of the invention.

What is claimed is:

1. A computer-implemented method for interoperation between a managed application and a Point-Of-Sale/Service (POS) device, comprising:
receiving a request for creating an instance of an object that implements an interface for the POS device;
determining an identifier associated with the object; and
dynamically generating programming instructions based on the identifier, wherein the programming instructions are arranged to enable the managed application and the POS device to access each other.

2. The method of claim 1, further comprising employing a POS for .NET library configured to provide properties, methods, and events associated with the POS device, wherein the POS device is a legacy device.

3. The method of claim 1, wherein executing the programming instructions comprises providing the managed application with one or more properties, methods and events associated with the POS device.

4. The method of claim 1, wherein the POS device includes at least one of: a bump bar; a cash changer; a cash drawer; a credit authorization terminal; a coin dispenser; a fiscal printer; a hard total; a keylock; a bar code scanner; a tone indicator; a motion detector; a line display; a magnetic ink character recognition reader; a magnetic stripe reader; a PIN pad; a point card; a POS keyboard; a POS printer; a remote order display; a scale; a signature capture; and a check image scanner.

5. The method of claim 1, wherein the programming instructions are an in-memory legacy proxy class.

6. The method of claim 1, wherein the object is a Control Object (CO) that is arranged to act as a device independent interface between the managed application and the POS device.

7. The method of claim 6, wherein the CO is associated with a Service Object (SO) that is arranged to act as a device dependent interface between the CO and the POS device.

8. The method of claim 6, wherein determining the identifier includes generating a legacy proxy class that is arranged to wrap an event sink interface of the CO.

9. The method of claim 1, wherein the dynamically generated programming instructions are arranged to provide calls from the POS device to one or more event handlers of a legacy proxy class associated with the POS device, so that the legacy proxy class translates and provides the calls to the managed application.

10. The method of claim 1, wherein the identifier is a unique identifier associated with the object.

11. A computer-readable medium having computer instructions for automated interoperation between a managed application and a legacy POS device, the instructions comprising:
receiving a request for creating an instance for a control object that implements an interface for the legacy POS device;
generating a legacy proxy class configured to translate and provide calls from the legacy POS device to the managed application;
retrieving a guid of an even sink interface of the control object; and
dynamically generating an in-memory legacy proxy class configured to provide calls from the legacy POS device to one or more event handlers of the legacy proxy class.

12. The computer-readable medium of claim 11, wherein the instructions further include receiving properties, methods, and events associated with the device from a POS for .NET library.

13. The computer-readable medium of claim 11, wherein the control object provides a device independent interface between the managed application and the legacy POS device, and the control object is associated with a Service Object (SO) that is arranged to act as a device dependent interface between the control object and the legacy POS device.

14. The computer-readable medium of claim 13, wherein the managed application is a .NET based application and the legacy SO for a POS device is an OPOS SO.

15. The computer-readable medium of claim 11, wherein the instructions further include retrieving the guid of the even sink interface from a connection point of an instance of the control object.

16. A system for integration of a POS device to a .NET-based POS application, comprising:
a public application programming interface (API) configured to determine when the POS device is a legacy device, generate a first set of programming instructions associated with the legacy POS device, and request a second set of programming instructions associated with the POS device, wherein the public API includes a library POS for .NET library configured to provide properties, methods and events associated with the device;
the POS application configured to interact with a device manager application associated with the POS device through the POS for .NET library and receive the properties, methods, and events associated with the device; and
a legacy interoperability subsystem configured to dynamically generate the second set of programming instructions, so that a first set and a second set of interfaces associated with the POS device are enabled to communicate with the POS application.

17. The system of claim 16, further comprising an internal enumerator of installed service objects configured to request dynamic generation of the second set of programming instructions from the legacy interoperability subsystem in response to the request from the public API.

18. The system of claim 16, wherein the first set of programming instructions is a legacy proxy class configured to wrap an event sink interface of each of the first set of interfaces and translate and provide calls from the POS device to the POS application, and wherein the second set of programming instructions is an in-memory legacy proxy class configured to provide calls from the POS device to one or more event handlers of the legacy proxy class.

19. The system of claim 16, wherein the first set of interfaces are Control Objects (COs) associated with one or more POS devices, and the second set of interfaces are corresponding Service Objects (SOs).

20. The system of claim 16, further comprising a reflection module within a .NET framework configured to emit the first set of programming instructions.
